(19) United States
(12) Patent Application Publication
(10) Pub. No.: US 2026/0081257 A1
(43) Pub. Date: Mar. 19, 2026

(54) TRACTION BATTERY PACK THERMAL MANAGEMENT SYSTEM

(71) Applicant: Ford Global Technologies, LLC, Dearborn, MI (US)

(72) Inventors: John Marshall Penney, Livonia, MI (US); Marc Bronzetti, Berkley, MI (US)

(21) Appl. No.: 18/886,024

(22) Filed: Sep. 16, 2024

(51) Int. Cl. H01M 10/6557; H01M 10/613; H01M 10/625; H01M 10/643; H01M 10/6568; H01M 50/213; H01M 50/249

(52) U.S. Cl. CPC H01M 10/6557; H01M 10/613; H01M 10/625; H01M 10/643; H01M 10/6568; H01M 50/213; H01M 50/249

(57) ABSTRACT

A battery pack thermal management system includes an outer conduit of a coolant conveying post, and an inner conduit of the coolant conveying post. The inner conduit disposed within the outer conduit. The coolant conveying post is configured to communicate coolant in a first direction through the outer conduit and outside of the inner conduit. The coolant conveying post is configured to communicate coolant in an opposite, second direction through the inner conduit.

### TECHNICAL FIELD

This disclosure relates generally to systems used to communicate a liquid coolant through battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a battery pack thermal management system, including: an outer conduit of a coolant conveying post; and an inner conduit of the coolant conveying post, the inner conduit disposed within the outer conduit, the coolant conveying post configured to communicate coolant in a first direction through the outer conduit and outside of the inner conduit, the coolant conveying post configured to communicate coolant in an opposite, second direction through the inner conduit.

In some aspects, the techniques described herein relate to a battery pack thermal management system, wherein the outer conduit has a triangular cross-section.

In some aspects, the techniques described herein relate to a battery pack thermal management system, wherein the inner conduit has a circular cross-section.

In some aspects, the techniques described herein relate to a battery pack thermal management system, wherein the coolant conveying post communicates coolant in the first direction through an annulus between the outer conduit and the inner conduit.

In some aspects, the techniques described herein relate to a battery pack thermal management system, wherein the coolant conveying post extends from a manifold assembly.

In some aspects, the techniques described herein relate to a battery pack thermal management system, wherein the manifold assembly includes a coolant inlet manifold and a coolant outlet manifold, wherein one of the outer conduit or the inner conduit opens to the coolant inlet manifold, wherein the other of the outer conduit or the inner conduit opens to the coolant outlet manifold.

In some aspects, the techniques described herein relate to a battery pack thermal management system, wherein the inner conduit extend past the outer conduit, through the coolant inlet manifold, and opens to the coolant outlet manifold.

In some aspects, the techniques described herein relate to a battery pack thermal management system, wherein the coolant outlet manifold is vertically beneath the coolant inlet manifold.

In some aspects, the techniques described herein relate to a battery pack thermal management system, further including a cover of the coolant conveying post, the cover closing an end of the outer conduit, wherein the inner conduit opens to a position within the outer conduit that is spaced from the cover.

In some aspects, the techniques described herein relate to a battery pack thermal management system, wherein the cover is configured to redirect flow moving through an annulus between the outer conduit and the inner conduit into the inner conduit.

In some aspects, the techniques described herein relate to a battery pack thermal management system, wherein the outer conduit includes a plurality of cell receiving surfaces that are each configured to interface with at least one battery cell.

In some aspects, the techniques described herein relate to a battery pack thermal management system, wherein the plurality of cell receiving surfaces are arcuate.

In some aspects, the techniques described herein relate to a battery pack thermal management system, wherein the plurality of cell receiving surfaces are concave.

In some aspects, the techniques described herein relate to a battery pack thermal management system, further including a plurality of cylindrical battery cells distributed circumferentially about a longitudinal axis of the coolant conveying post.

In some aspects, the techniques described herein relate to a battery pack thermal management system, wherein each of the cylindrical battery cells in the plurality of cylindrical battery cells is nested within a recessed area of the outer conduit.

In some aspects, the techniques described herein relate to a battery pack thermal management system, including: an enclosure assembly providing an interior area; a manifold assembly within the interior area; one or more coolant conveying posts extending from the manifold assembly; and a plurality of battery cells disposed circumferentially about each of the one or more coolant conveying posts, the one or more coolant conveying posts each configured to receive coolant from the manifold assembly and to redirect coolant back to the manifold assembly.

In some aspects, the techniques described herein relate to a battery pack thermal management system, wherein the one or more coolant conveying posts each include an inner conduit disposed within an outer conduit, the coolant conveying post configured to communicate coolant in a first direction through the outer conduit and outside of the inner conduit, the coolant conveying post configured to communicate coolant in an opposite, second direction through the inner conduit.

In some aspects, the techniques described herein relate to a battery pack thermal management system, wherein the outer conduit receives coolant from an inlet manifold of the manifold assembly, and the inner conduit delivers coolant to an outlet manifold of the manifold assembly.

In some aspects, the techniques described herein relate to a battery pack thermal management system, wherein the plurality of battery cells are a plurality of cylindrical battery cells.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a closeup view of a coolant conveying post from the battery pack of FIG. 2.

FIG. 4 illustrates a closeup view of battery cells disposed about coolant conveying posts that extend from a manifold assembly within the battery pack of FIG. 2.

FIG. 5 illustrates a closeup view of a portion of FIG. 4 with a cover of the coolant conveying post partially removed.

FIG. 6 illustrates a section view through an area of FIG. 4.

### DETAILED DESCRIPTION

This disclosure details exemplary thermal management systems used to convey liquid coolant within a traction battery pack. The systems are particularly appropriate for battery packs having cylindrical battery cells.

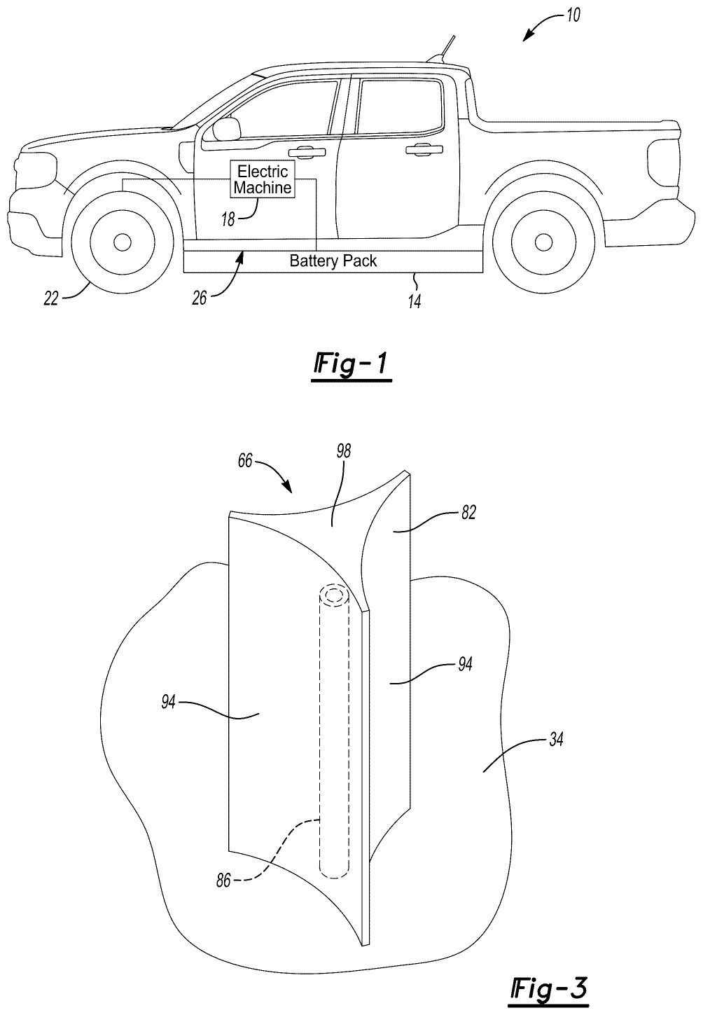

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

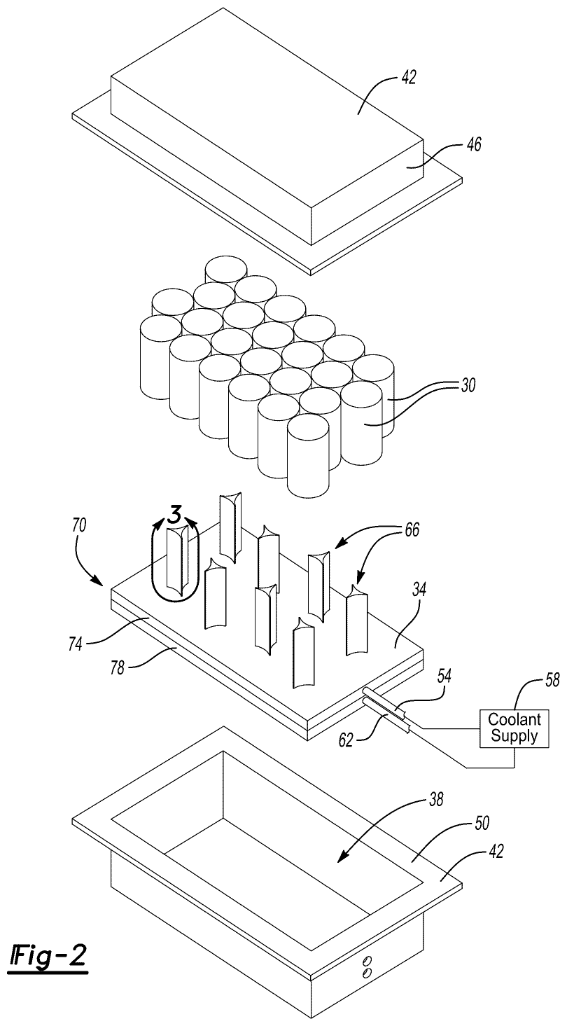

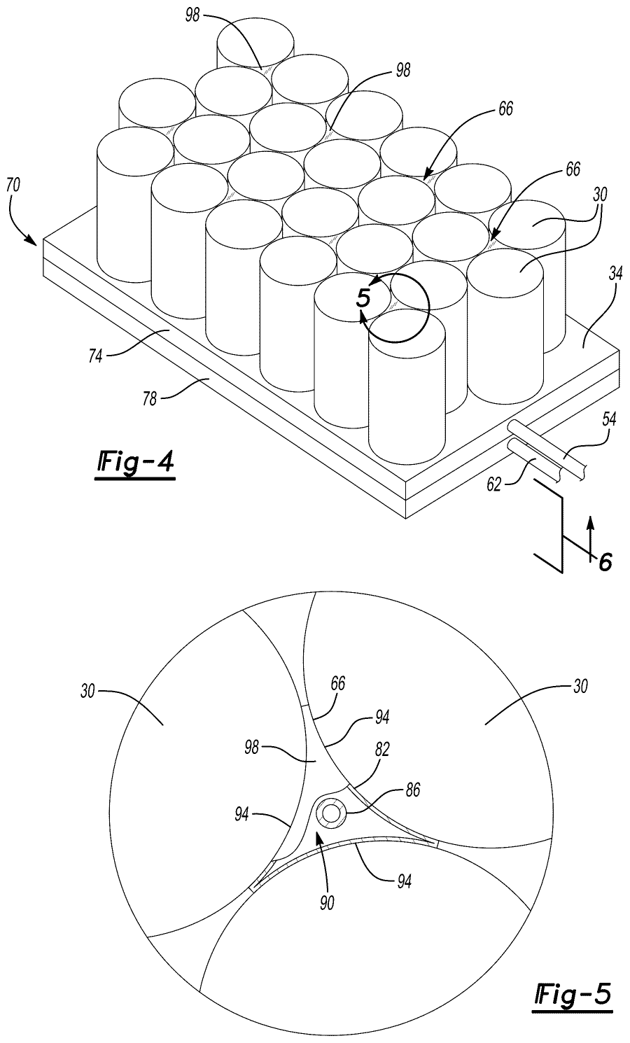

With reference now to FIG. 2-6 and continuing reference to FIG. 1, the battery pack 14 includes a plurality of battery cells 30 and a thermal management assembly 34 disposed within an interior area 38 provided by an enclosure assembly 42. In this example, the enclosure assembly 42 comprises an enclosure cover 46 and an enclosure tray 50.

The battery cells 30 are cylindrical battery cells in this example. The thermal management assembly 34 can be used to communicate a coolant, such as a liquid coolant, that is delivered through an inlet 54 from a coolant supply 58 that is outside the battery pack 14. The coolant circulates through the thermal management assembly 34 to, for example, take on thermal energy from the cells 30 thereby cooling the cells 30. The coolant then exits the thermal management assembly 34 and the battery pack 14 through an outlet 62.

Outside the battery pack 14, the coolant can be routed through a heat exchanger to exchange thermal energy from the coolant. The coolant can then be reintroduced to the coolant supply 58 for recirculation through the battery pack 14.

Although the exemplary thermal management assembly 34 and its coolant are utilized to cool the battery cells 30 and other areas of the battery pack 14, the coolant could be used to heat the battery cells 30 or other areas of the battery pack 14 in other examples.

The cells 30, in this example, are cylindrical battery cells having a jellyroll-style electrode structure housed within an outer casing assembly. The cells 30 interface with various area of the thermal management assembly 34 to facilitate transfer of thermal energy between the thermal management assembly 34 and the cells 30.

In this example, the thermal management assembly 34 includes a plurality of coolant conveying posts 66 extending from a manifold assembly 70. The example posts 66 extend vertically upward from the manifold assembly 70. Vertical, for purposes of this disclosure is with reference to ground in a general orientation of the battery pack 14 when installed within the vehicle 10 of FIG. 1. In another example, the posts 66 could extend horizontally from the manifold assembly 70 or in some other direction. The posts 66 and the manifold assembly 70 can be a metal or metal-alloy. In a specific example, the posts 66 and the manifold assembly 70 are aluminum.

The manifold assembly 70 includes an inlet manifold 74 and an outlet manifold 78. The inlet manifold 74 is vertically above the outlet manifold 78. Coolant delivered through the inlet 54 flows into the inlet manifold 74. Generally, the posts 66 receive coolant from the inlet manifold 74 and then redirect the coolant back to the outlet manifold 78 of the manifold assembly 70.

The posts 66 each include an outer conduit 82 and an inner conduit 86. The inner conduit 86 is disposed within the outer conduit 82 to establishes an annulus 90 between the inner conduit 86 and the outer conduit 82.

Vertical lower ends of the outer conduits 82 opens to the inlet manifold 74. Coolant flowing through the inlet manifold 74 flows, in this example, upward into the posts 66 through the annulus 90. The coolant flowing through the annulus 90 can take on thermal energy from the battery cells 30 distributed about a longitudinal axis of the associated post 66.

The outer conduit 82 has a triangular cross-section. The outer conduit 82 can be referred to as a trident in some examples.

The outer conduit 82 has three sides 94 that are arcuate. The sides 94 are concave relative to the battery cells 30. The sides 94 each provide a recessed area to accommodate a portion of one of the battery cells 30. When the cells 30 are distributed about the outer conduit 82 of the posts 66, a portion of the cell 30 nests within one of the recessed areas provided by one of the sides 94. The sides 94 can be considered cell receiving sides.

As the sides 94 track a curvature of the cells 30, the side 94 can contact one of the battery cells 30 across an entirety of the side 94. This relatively large contact area can facilitate thermal energy transfer between the cells 30 and the side 94.

Again, a vertical lower end of the outer conduit 82 opens to the inlet manifold 74. Coolant enters the annulus 90 through the open end of the outer conduit 82. An opposite end of the outer conduit 82 is capped by a cover 98.

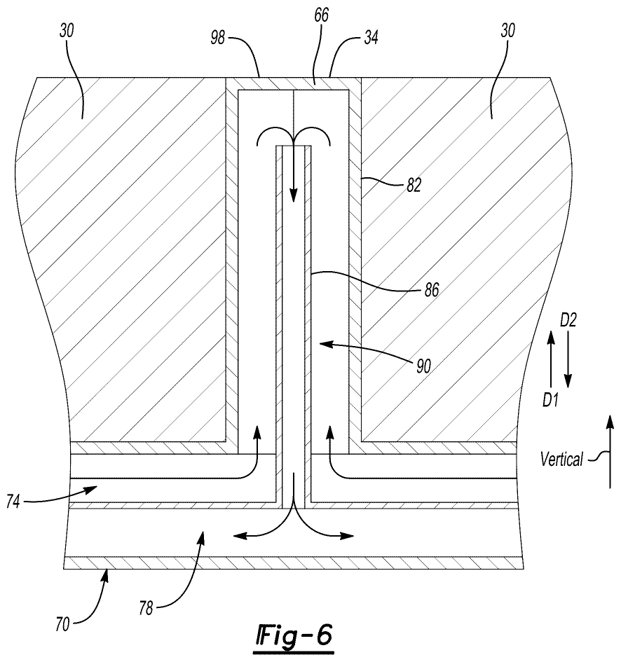

The inner conduit 86 extends vertically upward and terminates at a position short of the cover 98. The inner conduit 86 is cylindrical in this example and thus has a circular cross-section. Other cross-sectional profiles could be used in other examples, such as a square or rectangular profile. The inner conduit 86 is open at a vertical upper end. An opposite second end of the inner conduit 86 opens to the outlet manifold 78. The inner conduit 86 extends through the inlet manifold 74 to reach the outlet manifold 78 (FIG. 6).

Coolant that has communicated through the annulus 90 vertically upward in a first direction is eventually redirected by the cover 98 into the inner conduit 86. The inner conduit 86 conveys this fluid vertically downward in a second, opposite direction, into the outlet manifold 78.

From the outlet manifold 78 the coolant can move through the outlet 62 from the battery pack 14. A cross-sectional size of the outer conduit 82 and the inner conduit 86 can be adjusted to facilitate flow from the annulus 90 into the inner conduit 86. In an example, cross-sectional area of the inner conduit 86 can be about the same as a cross-sectional area of the annulus 90.

Although the example coolant conveying posts 66 includes three sides 94 each interfacing directly with a single one of the battery cells 30, other arrangements are contemplated and fall within the scope of this disclosure. For example, the outer conduit 84 could be provided with six sides, and each of those six sides could interface directly with a single battery cell. In such an example, six battery cells would be distributed circumferentially about the six sided coolant conveying posts.

Features of the disclosed examples include a thermal management assembly that can communicate coolant to manage thermal energy without substantially increasing an overall packaging size of the battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack thermal management system, comprising:
an outer conduit of a coolant conveying post; and
an inner conduit of the coolant conveying post, the inner conduit disposed within the outer conduit, the coolant conveying post configured to communicate coolant in a first direction through the outer conduit and outside of the inner conduit, the coolant conveying post configured to communicate coolant in an opposite, second direction through the inner conduit.

2. The battery pack thermal management system of claim 1, wherein the outer conduit has a triangular cross-section.

3. The battery pack thermal management system of claim 1, wherein the inner conduit has a circular cross-section.

4. The battery pack thermal management system of claim 1, wherein the coolant conveying post communicates coolant in the first direction through an annulus between the outer conduit and the inner conduit.

5. The battery pack thermal management system of claim 1, wherein the coolant conveying post extends from a manifold assembly.

6. The battery pack thermal management system of claim 5, wherein the manifold assembly includes an coolant inlet manifold and a coolant outlet manifold, wherein one of the outer conduit or the inner conduit opens to the coolant inlet manifold, wherein the other of the outer conduit or the inner conduit opens to the coolant outlet manifold.

7. The battery pack thermal management system of claim 6, wherein the inner conduit extend past the outer conduit, through the coolant inlet manifold, and opens to the coolant outlet manifold.

8. The battery pack thermal management system of claim 7, wherein the coolant outlet manifold is vertically beneath the coolant inlet manifold.

9. The battery pack thermal management system of claim 1, further comprising a cover of the coolant conveying post, the cover closing an end of the outer conduit, wherein the inner conduit opens to a position within the outer conduit that is spaced from the cover.

10. The battery pack thermal management system of claim 9, wherein the cover is configured to redirect flow moving through an annulus between the outer conduit and the inner conduit into the inner conduit.

11. The battery pack thermal management system of claim 1, wherein the outer conduit comprises a plurality of cell receiving surfaces that are each configured to interface with at least one battery cell.

12. The battery pack thermal management system of claim 11, wherein the plurality of cell receiving surfaces are arcuate.

13. The battery pack thermal management system of claim 11, wherein the plurality of cell receiving surfaces are concave.

14. The battery pack thermal management system of claim 1, further comprising a plurality of cylindrical battery cells distributed circumferentially about a longitudinal axis of the coolant conveying post.

15. The battery pack thermal management system of claim 14, wherein each of the cylindrical battery cells in the plurality of cylindrical battery cells is nested within a recessed area of the outer conduit.

16. A battery pack thermal management system, comprising:
an enclosure assembly providing an interior area;
a manifold assembly within the interior area;
one or more coolant conveying posts extending from the manifold assembly; and
a plurality of battery cells disposed circumferentially about each of the one or more coolant conveying posts, the one or more coolant conveying posts each configured to receive coolant from the manifold assembly and to redirect coolant back to the manifold assembly.

17. The battery pack thermal management system of claim 16, wherein the one or more coolant conveying posts each include an inner conduit disposed within an outer conduit, the coolant conveying posts each configured to communicate coolant in a first direction through the outer conduit and outside of the inner conduit, the coolant conveying posts each configured to communicate coolant in an opposite, second direction through the inner conduit.

18. The battery pack thermal management system of claim 17, wherein the outer conduit receives coolant from an inlet manifold of the manifold assembly, and the inner conduit delivers coolant to an outlet manifold of the manifold assembly.

19. The battery pack thermal management system of claim 16, wherein the plurality of battery cells are a plurality of cylindrical battery cells.
